(19) United States
(12) Patent Application Publication
(10) Pub. No.: US 2003/0184519 A1
(43) Pub. Date: Oct. 2, 2003

(54) Gripping type computer mouse device

(76) Inventor: Cheng-Tsung Liu, Taipei (TW)

Correspondence Address: BRUCE H. TROXELL, SUITE 1404, 5205 LEESBURG PIKE, FALLS CHURCH, VA, 22041, US

(21) Appl. No.: 10/106,356

(22) Filed: Mar. 27, 2002

(51) Int. Cl. G09G 5/08

(52) U.S. Cl. 345/163

(57) ABSTRACT

A gripping type computer mouse device consists of a handgrip, a plurality of button keys and a signal editor. The handgrip has an exterior shape matching an user's palm to allow the user to grasp the mouse device with one hand. The button keys are located on positions corresponding to user's fingers to facilitate user pressing operation. Command signals are generated when the button keys are depressed. The signal editor based on moving distance of the mouse device generates track signals.

### FIELD OF THE INVENTION

The present invention relates to a computer mouse device and particularly to a gripping type computer mouse to facilitate user operation by gripping with a hand.

### BACKGROUND OF THE INVENTION

The flourishing development of computer game software and huge popularity of WINDOWS operating systems have made mouse device an indispensable computer peripheral device. Through the mouse, users can control cursor, select (open) data or input operation commands. To accomplish the function of controlling cursor and operation commands, the mouse generally is equipped with a signal editor and button keys. The signal editor, based on moving direction and distance of the mouse, can generate corresponding track signals for the cursor on the screen. The button keys enable users to generate command signals by depressing the buttons. As users generally use palm to operate the mouse, the exterior shapes of most mouse devices now available on the market are designed to match user' palms.

Refer to FIGS. 1A and 1B for a conventional computer mouse. The mouse 10 includes a body 11, a sliding surface 12, a plurality of buttons 13 and a signal editor (not shown in the drawings). The body 11 is formed substantially in a semi-ellipsoid shape with an exterior profile fitting for a human palm. The sliding surface 12 is located under the body 11. The mouse 10 may be slid and moved horizontally on a table top when in use. The mouse 10 generally has two or three buttons. Of course the number of button can be increased or decreased as required. The buttons 13 are preferably located at the front end of the body 11. The signal editor mainly generates corresponding track signals for the cursor on the screen based on the moving direction and distance of the mouse 10. In order to enable the signal editor to accomplish aforesaid function, there are generally a rolling ball 14 and a directional spindle 15 mounted to the sliding surface 12 of the mouse 10. When an user slides the mouse 10 on the tabletop, the rolling ball 14 rotates and drives the directional spindle 15 to rotate simultaneously. Data of the rotation of the directional spindle 15 and the moving direction of the mouse 10 are fed to the signal editor which edits and processes to generate corresponding track signals for the cursor on the computer screen.

Although conventional mouse devices may have different exterior shapes, user operations of the mouse are mostly similar. In general, an user holds the rear end of the mouse body with the palm of one hand, with the thumb and third and fourth finger gripping the mouse body, and with the index finger and middle finger to operate the buttons located on the front end of the body. When in use, user's wrist moves, and the palm moves the mouse at the same time on the tabletop.

Conventional techniques set forth above still have drawbacks. One of them is that they do not conform to ergonomics. When users operate the mouse, they usually have to raise the palm and rest the palm on the tabletop. Operating with this gesture for a long period of time could incur wrist pain. Another problem is poor controllability. Operating conventional mouse requires user's palm facing down to grasp the mouse body. It is different from playing computer games. Most computer game players are accustomed to joy sticks rather than mouse devices. However a great portion of computer game software are still designed based on mouse operation and control. It creates a lot of inconveniences to the great population of computer game players.

In view of aforesaid disadvantages, an improved mouse that is designed based on ergonomics and can provide better controllability will help to alleviate the harmful effect on users' health and offer great benefits to most computer game layers.

### SUMMARY OF THE INVENTION

The primary object of the invention is to provide a gripping type computer mouse device that enables users to grasp with one hand like a joy stick to achieve better controllability during operation.

Another object of the invention is to provide a gripping type computer mouse device that offers an operating method better conforming to ergonomics to prevent users from inflicting pains or discomfort after long time of operation.

The gripping type computer mouse device according to the invention consists of a handgrip, a plurality of button keys and a signal editor. The handgrip is formed like a joy stick used in general computer games to fit smugly with user's palm and enables users to hold the mouse by a hand gripping method. The handgrip has a bottom surface which is enlarged to increase stability when moving on a flat surface (such as tabletop). The button keys are preferably to be three, including a first key (left key), a second key (right key) and a third key (roller middle key). They are located on positions corresponding to user's index finger, middle finger and thumb when the handgrip is held by user's hand such that the index finger may press the first key, the middle finger may press the second key, and the thumb may press the third key to generate command signals.

The signal editor can generate corresponding track signals for the cursor on the screen based on the moving direction and distance of the mouse. In order to generate the track signals, the invention provides a rolling ball and a directional spindle on the bottom surface of the mouse. When an users slides the mouse on the tabletop, the rolling ball on the bottom surface rotates and drives the directional spindle to rotate. The signal editor based on the rotation of the directional spindle edits and determines the moving distance and direction of the mouse and generates corresponding track signals for the cursor on the computer screen. In another embodiment of the invention, the bottom surface of the handgrip has an optical sensor which can sense moving distance and direction of the mouse on the tabletop and transmit to the signal editor for processing and editing, and generate corresponding track signals for the cursor on the computer screen.

Communication between the computer mouse of the invention and the processor may be through a wired or wireless transmission. When adopting wired transmission, the connector types may be USB, PS2, SERIAL or the like. For wireless transmission, infrared light transmission means may be adopted. The operating systems may include WINDOWS operating systems offered by Microsoft Co. or McIntosh operation systems offered by Apple Co. To meet the requirements of a huge population of computer game software players, the computer mouse of the invention may be coupled with the game processors such as PS2 or X-BOX to offer dynamic feedback function and give game players more exciting and entertaining effect.

The computer mouse of the invention not only provides better controllability, its operation method is also more ergonomic than conventional techniques, and can prevent users from hurting or inflicting pains after long time of operation, and offers users more conveniences and friendly operations.

The foregoing, as well as additional objects, features and advantages of the invention will be more readily apparent from the following detailed description, which proceeds with reference to the accompanying drawings.

### BRIEF DESCRIPTION OF THE DRAWINGS

FIGS. 1 and 2 are schematic views of a conventional computer mouse device.

FIGS. 2A through 2E are various side views of the gripping type computer mouse device of the invention.

FIG. 3 is a bottom view of another embodiment of the invention.

### DESCRIPTION OF THE PREFERRED EMBODIMENTS

The invention aims at providing a computer mouse design that employs a handgrip approach to control mouse operation thereby to achieve better controllability and improved ergonomics, and to prevent users from inflicting harmful effects after long time of operation. Preferred embodiments and details of the invention are discussed below.

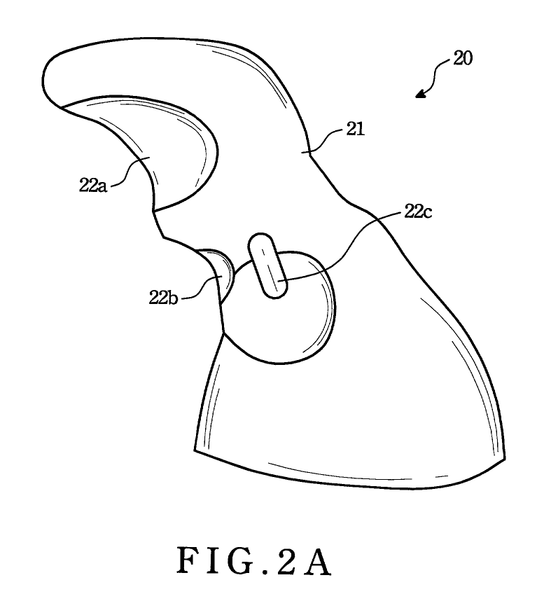

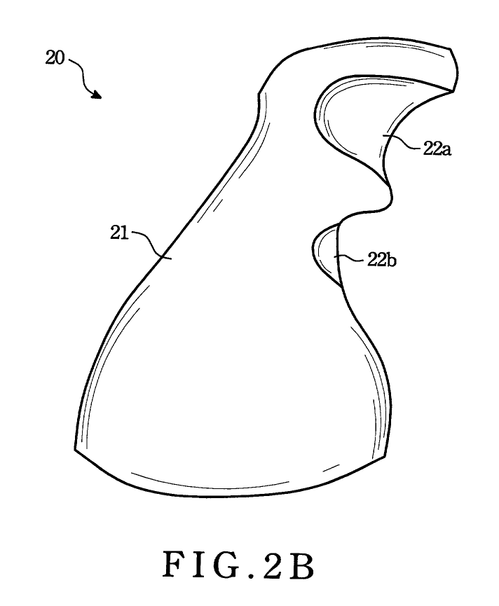

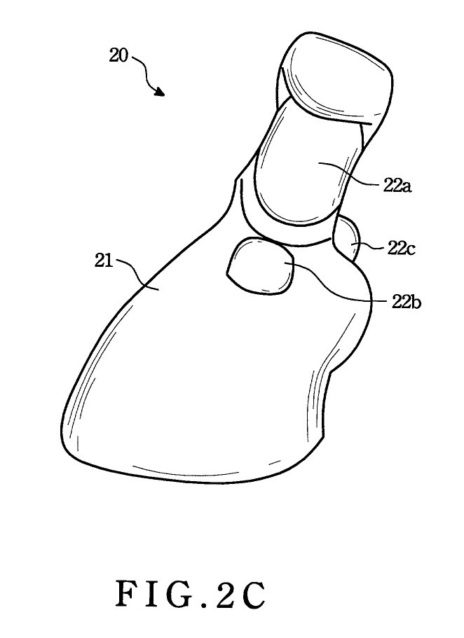

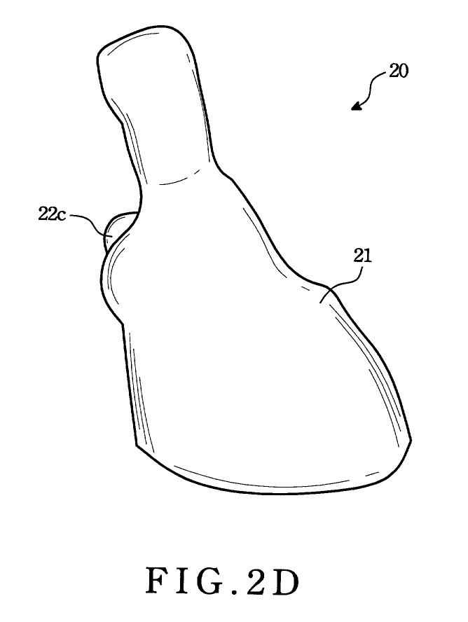

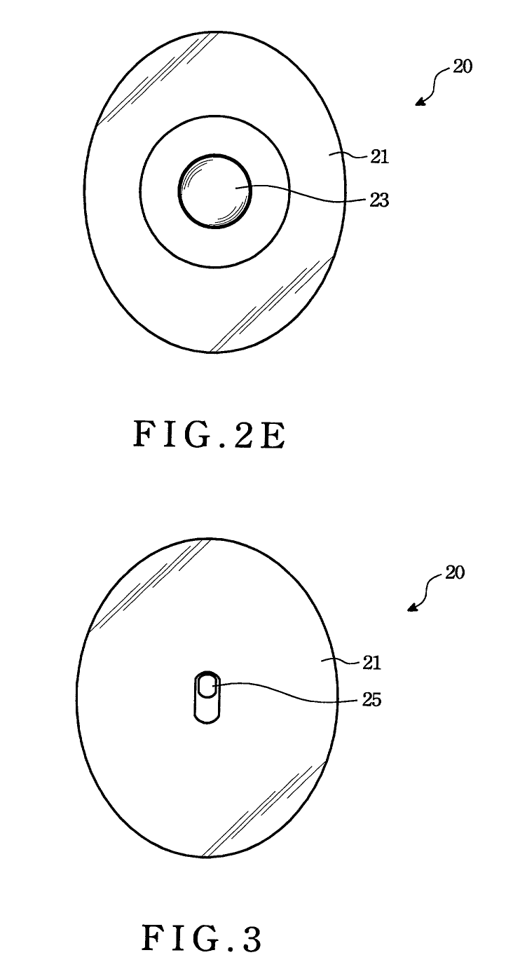

Referring to FIGS. 2A through 2E, the gripping type computer mouse device 20 of the invention consists of a handgrip 21, a plurality of button keys 22 and a signal editor (not shown in the drawings).

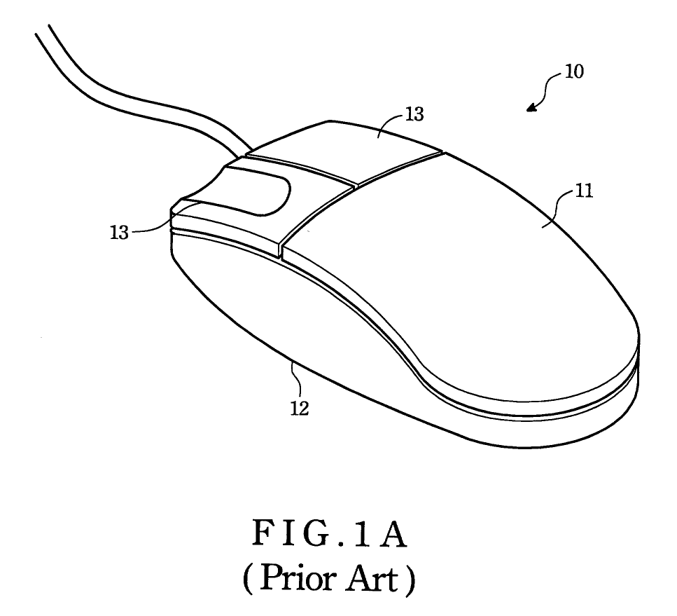

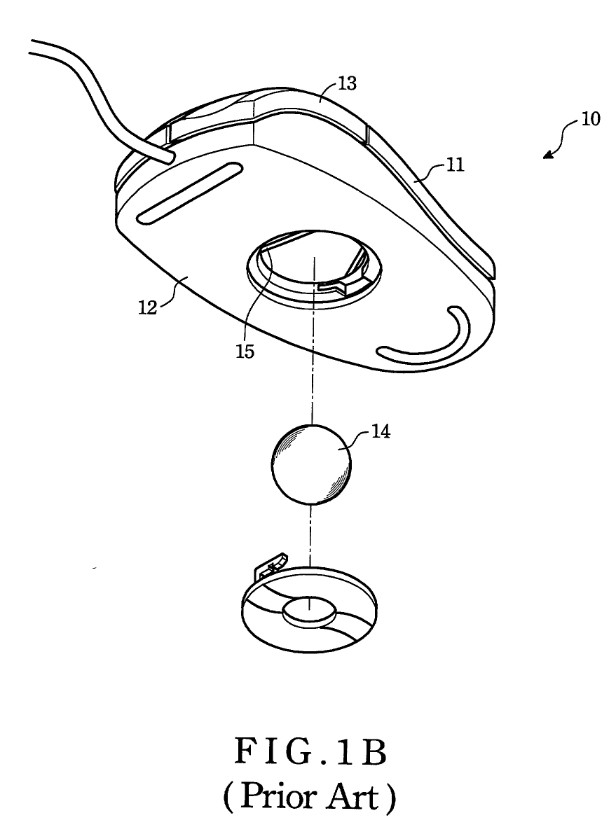

The biggest novel feature of the mouse device 20 of the invention is to part from conventional mouse exterior design (as shown in FIG. 1A) and adopts the handgrip 21 which has an exterior shape substantially like a joy stick that is commonly used in computer games. Hence users may grasp the handgrip 21 in a vertical condition. The handgrip 21 is designed and formed to match user's palm and allows an user to grasp with one hand. The bottom surface of the handgrip 21 is enlarged to increase stability when the mouse device 20 is moved on a flat surface (tabletop). The number of the button keys 22 on the mouse device 20 is preferably three, including a first key 22a (left key), a second key (right key) and a third key (roller middle key). Their locations on the handgrip 21 are corresponding to user's index finger, middle finger and thumb when the handgrip 21 is held by user's hand. When an user operates the computer mouse device 20, the index finger may press the first key 22a, the middle finger may press the second key 22b, and the thumb may press the third key 22c to turn the roller and generate command signals.

The signal editor is located inside the handgrip 21 of the mouse device 20, and may base on moving distance and direction of the mouse device 20 to generate corresponding track signals for the cursor on the screen, thereby achieve the object of converting the moving distance and direction to track signals. In an embodiment of the invention, the bottom surface of the handgrip 21 has a rolling ball 23 and a directional spindle (not shown in the drawings) located thereon. The rolling ball 23 may roll on the tabletop when an user moves the mouse device 20 on the tabletop. When the rolling ball 23 rotates, it drives the directional spindle rotating too. Then the signal editor based on the rotation of the directional spindle, processes and edits and generates corresponding track signals for the cursor on the computer screen. Another preferred embodiment of the invention is to employ an optical sensor 25 (as shown in FIG. 3) mounting on the bottom surface of the handgrip 21. The optical sensor 25 can sense moving distance and direction of the mouse device 20 on the tabletop, and signals are transmitted to the signal editor for processing and editing, then corresponding track signals for the cursor on the computer screen are generated.

Communication between the computer mouse device of the invention and the processor may be achieved through wired or wireless transmission. When adopting wired transmission, the connector types may be USB, PS2, SERIAL or the likes. For wireless transmission, infrared light transmission means may be adopted. The operating systems applicable for the invention may include WINDOWS operating systems offered by Microsoft Co. or McIntosh operation systems offered by Apple Co. To meet the requirements of a huge population of computer game software players, the computer mouse device of the invention may offer dynamic feedback function, such as concurrently generating a recoil when playing a shooting game, concurrently generating centrifugal force when playing racing car at a turn, or the likes, thus gives game players more realistic onsite feeling and better controllability, and achieves more exciting and entertaining effect. The techniques of dynamic feedback are known in the art, thus are omitted here.

By means of the construction set forth above, the computer mouse device of the invention not only provides better controllability, its operation method is also more ergonomic than conventional techniques, and can prevent users from hurting or inflicting pains after long time of operation, and offers users more conveniences and friendly operations.

While the preferred embodiments of the invention have been set forth for the purpose of disclosure, modifications of the disclosed embodiments of the invention as well as other embodiments thereof may occur to those skilled in the art. Accordingly, the appended claims are intended to cover all embodiments which do not depart from the spirit and scope of the invention.

What is claimed is:

1. A gripping type computer mouse device, comprising:
a handgrip having an exterior shape to match a human palm to allow an user to grasp the handgrip with the palm of one hand;
at least one button key located on positions corresponding to user's fingers when the user grasps the handgrip for generating command signals when depressed; and
a signal editor for generating track signals based on moving distance and direction of the mouse device.

2. The gripping type computer mouse device of claim 1, wherein the handgrip has a flat bottom surface to facilitate the mouse device moving on a tabletop.

3. The gripping type computer mouse device of claim 1, wherein the handgrip has bottom surface with a rolling ball and a directional spindle located thereon, the directional spindle being driven to rotate when the mouse device is moved on a tabletop thereby the signal editor based on the rotation of the directional spindle editing and determining moving distance and direction of the mouse device, and generating corresponding track signals for the cursor on a computer screen.

4. The gripping type computer mouse device of claim 1, wherein the handgrip has a bottom surface with an optical sensor located thereon, the optical sensor transmitting data of moving distance and direction of the mouse device on a tabletop to the signal editor, and the signal editor based on rotation of a directional spindle editing and determining moving distance and direction of the mouse device, and generating corresponding track signals for the cursor on a computer screen.

5. The gripping type computer mouse device of claim 1, wherein the button key includes at least a left key and a right key respectively corresponding to an index finger and a middle finger of the user.

6. The gripping type computer mouse device of claim 5, wherein the button key further includes a middle key corresponding to a thumb of the user.

7. The gripping type computer mouse device of claim 1, wherein the computer mouse device communicates with a processor through wired transmission with connectors selected from the group consisting of USB, PS2 or SERIAL.

8. The gripping type computer mouse device of claim 1, wherein the computer mouse device communicates with a processor through wireless transmission and employs infrared light for transmission.

9. The gripping type computer mouse device of claim 1 further including dynamic feedback function.

10. The gripping type computer mouse device of claim 1, wherein the computer mouse device selectively operates in Microsoft's WINDOWS operations systems, or Apple's McIntosh operating systems, or PS2 or X-BOX game processors.
